(19) United States
(12) Patent Application Publication
(10) Pub. No.: US 2009/0025528 A1
(43) Pub. Date: Jan. 29, 2009

(54) Tuning peg element

(75) Inventor: Georg Vochezer, Argenbuehl-Christazhofen (DE)

Correspondence Address: Lipsitz & McAllister, LLC, 755 MAIN STREET, MONROE, CT, 06468, US

(73) Assignee: Wittner GmbH & Co. KG, Isny (DE)

(21) Appl. No.: 12/228,431

(22) Filed: Aug. 11, 2008

Related U.S. Application Data
(63) Continuation of application No. PCT/EP2007/001221, filed on Feb. 13, 2007.

(30) Foreign Application Priority Data
Feb. 15, 2006 (DE) 10 2006 007 970.1

(51) Int. Cl. G10D 3/14

(52) U.S. Cl. 84/304; 84/305

(57) ABSTRACT

To provide a tuning peg element for a stringed musical instrument having a wooden peg box, a conical fixing part is provided, by means of which the tuning peg element is fixable to the peg box in rotatable manner without further auxiliary means and which is of solid construction and is made of a non-fibrous material at least in a region of contact with the peg box.

This application is a continuation of international application number PCT/EP2007/001221 filed on Feb. 13, 2007.

The present disclosure relates to the subject matter disclosed in international application number PCT/EP2007/001221 of Feb. 13, 2007 and German application number 10 2006 007 970.1 of Feb. 15, 2006, which are incorporated herein by reference in their entirety and for all purposes.

### BACKGROUND OF THE INVENTION

The invention relates to a tuning peg element for a stringed musical instrument having a wooden peg box, comprising a conical fixing part by means of which the tuning peg element is fixable in the peg box in rotatable manner.

The strings of a stringed musical instrument such as a violin, a viola or a cello for example are held on the peg box by tuning peg elements.

Tuning peg elements are, for example, known from the publications GB 239,984, U.S. Pat. No. 316,658, U.S. Pat. No. 639,341, U.S. Pat. No. 360,186, U.S. Pat. No. 361,500, U.S. Pat. No. 1,135,314, U.S. Pat. No. 1,351,616, U.S. Pat. No. 1,422,738, U.S. Pat. No. 1,443,486, U.S. Pat. No. 1,506,373, U.S. Pat. No. 1,554,772, U.S. Pat. No. 1,604,367, U.S. Pat. No. 1,669,824, U.S. Pat. No. 1,672,348, U.S. Pat. No. 1,710,802, U.S. Pat. No. 1,802,937, U.S. Pat. No. 3,459,092, U.S. Pat. No. 3,726,172, U.S. Pat. No. 4,026,182, U.S. Pat. No. 4,077,295, U.S. Pat. No. 4,735,124, U.S. Pat. No. 5,767,427, U.S. Pat. No. 5,998,713, GB 21,056, CA 2 366 329, AT 006 900 U1, DE 20 2004 008 465 U1, EP 1 453 034 A2 or EP 1 178 464 A1.

From DE 1 807 705, there is known a slip-free tuning peg for bowed instruments which has a round and conical shank. There is a central longitudinal bore in the rear end of the shank of the tuning peg. A tightening screw which is effective on the rear end of the tuning peg shank is provided as is also a guard ring that is arranged between the head of the tightening screw and the peg box. The shank of the tuning peg has a transverse slot extending over its entire width at the rear end thereof. The inner surface of the guard ring has arc-shaped flanges which match the transverse slot in the shank of the tuning peg and it is provided with a conically inwardly tapering annular surface. The tightening screw engages directly in the longitudinal bore in the shank of the tuning peg.

From DE 203 03 120 U1, there is known a fine tuning peg for stringed instruments having a slightly conically tapering tuning peg shank, wherein the shank of the tuning peg is formed over its axial extent from two mutually coaxially extending tuning peg shank parts and a transmission gear is provided. Noses or cams are provided on the two parts of the tuning peg shank for engaging in fixed wooden restrainers of a peg box.

From DE 529 173, there is known a tuning peg for bowed instruments which consists of a piece of light metal. A screw is provided for preventing the tuning peg cone from slipping out, said screw bearing on the external wall of the peg box and the depth to which it is seated and thus the amount of thread projecting being varied in regulated manner by means of different washers.

From DE 20 2004 005 197 U1, there is known a means for accommodating a tuning peg in the peg box of bowed instruments, wherein for this purpose the peg box has a conical bore which consist of a non-woody material, namely a metal or a synthetic material.

### SUMMARY OF THE INVENTION

In accordance with the present invention, a tuning peg element is provided, which is utilisable in a simple manner.

In accordance with an embodiment of the invention, the fixing part is fixable to the peg box in rotatable manner without further auxiliary means, is of solid construction and is made of a non-fibrous material at least in a region of contact with the peg box.

The tuning peg element in accordance with the invention is fixable to the peg box merely by means of the conical fixing part by virtue of the static frictional force and without the need for further additional auxiliary means such as clamping means or screws or knife-edge elements. The production and assembly thereof is thereby simplified. Furthermore, a musician's use thereof is simplified since he does not have to “operate” the additional auxiliary means.

Since, in the case of the solution in accordance with the invention, no additional form of clamping to the peg box is envisaged, a region of contact between the tuning peg element and the peg box can be provided which substantially corresponds to that region of the surface of the tuning peg element which is arranged in a bore in the peg box. Good seating of the tuning peg element is thereby achieved, whereby the wear is distributed over a large surface area and not, for example, merely over a partial annular region of this surface area; the latter is the case, when clamping is effected as in DE 1 807 705. Due to the solution in accordance with the invention utilising a large area of contact, the tuning peg element can be prevented from slipping inwardly as it becomes worn. Furthermore, climatic fluctuations can be accommodated. The tuning peg element in accordance with the invention has a long life span due to the wear thereof being evenly distributed.

The fixing part is a “filled out” block of material having a conical outline. Thereby, the block of material can be formed in one piece or comprise several parts; in the latter case for example, an outer sleeve of non-fibrous material is seated on an interior core.

As a result of the solid construction of the fixing part from a solid material without auxiliary means for fixing purposes being arranged on the fixing part, it becomes possible to easily adapt to the proportions of a specific stringed musical instrument by means of a tuning peg cutter for example. Furthermore, the tuning peg element is then producible in a simple manner.

Tuning peg elements made of wood are known; for example, tuning peg elements made of ebony are known. Here however, the problem arises that the direction of the grain of such a wooden tuning peg element runs transverse to the direction of the grain of the wood of the peg box. The end faces of the wood fibres of the peg box thus abut on the wood fibres of the tuning peg element in the load direction of the tuning peg element. This causes more rapid wear of the wooden tuning peg element so that this has to be replaced at an earlier time. Furthermore, a bore in the peg box wears out more quickly; this must then be re-bored and thereby becomes larger whereby a new tuning peg element is necessary. It can even happen that the bore will then be too large as a result of the re-bore process and will have to be made smaller by means of a lining bush.

In accordance with the invention, the tuning peg element of the fixing part is made of a non-fibrous material at least in the region of contact and is accordingly, homogeneous. Abutment of the end grain of wooden fibres on other wood fibres is thereby prevented. Thus, in turn, the wear of the tuning peg element and of the peg box is reduced.

Furthermore, the stick-slip effect can thereby be reduced whereby the process of tuning the musical instrument is made easier since the static friction is smaller. In order to be able to turn a tuning peg element in a peg box at all, a certain threshold moment must be exerted. In the case of a large static frictional force and accordingly a small sliding frictional force, excess rotation of the tuning peg element can occur after reaching the threshold whereby the string is made shorter than desired so that the tuning process must be repeated. Due to the solution in accordance with the invention, the stick-slip effect can be reduced.

It has proved to be expedient if the surface pressure on the fixing part is between 3.1 N/mm² and 4.3 N/mm² when the tuning peg element is fixed to the peg box. In particular, the surface pressure is approximately 3.7 N/mm². At these surface pressure values which are attainable without additional auxiliary means such as clamping elements, there is a uniform application of force over the entire contact surface area of the fixing part. The fixing part can be fixed securely to the peg box. The wear can be kept low since it is distributed over a large surface area. Furthermore, the stick-slip effect can be reduced.

In particular, the end face of the fixing part is free from recesses. Since no additional auxiliary means for fixing the tuning peg element to the peg box are necessary, recesses for additional auxiliary elements such as clamping elements are also not necessary. Thus, in turn, the tuning peg element can be manufactured in a simple manner. Furthermore, it is workable in a simple manner by means of a tuning peg cutter for example.

In particular, a front end face of the tuning peg element is formed on the fixing part. Auxiliary means such as screws or the like are not arranged on the fixing part so that an outer end face of the fixing part also forms an outer end face of the tuning peg element.

It is expedient if the front end face is closed and in particular has no recesses such as slots and the like. The corresponding tuning peg element is thereby producible and workable in a simple manner.

For the same reason, it is expedient if the front end face is formed by the solid material of the fixing part.

It is especially very advantageous, if the region of contact of the fixing part with the peg box substantially corresponds to the surface region which is positioned in a bore in the peg box. There is thus a large region of contact between the tuning peg element and the peg box and thus the wear can be distributed over a large surface area. By appropriate adaptation to the peg box, the tuning peg element can be fixed securely thereto and the tuning peg element does not slip inwardly with wear. Climatic fluctuations can be accommodated and a long life span is obtained.

It is especially very advantageous, if the fixing part is workable by a tuning peg cutter. An example of a tuning peg cutter is disclosed in the not pre-published German patent application No. 10 2006 013 437.0 dated 14 Mar. 2006 or in US 2007/0214938. The machining process using a tuning peg cutter can be effected by an instrument maker. He can then match the tuning peg element to a specific stringed musical instrument. Optimal matching can thus be obtained whereby the specific properties of a particular stringed musical instrument are taken into consideration. The matching process effected by the instrument maker can be carried out in a simple manner. Furthermore, he only needs to keep a small number of different tuning peg elements in stock since adaptation thereof is easily possible.

In particular, one or more basic models are provided for the tuning peg element from which tuning peg elements of differing conical slopes and/or different sizes (in regard to the length and diameter thereof) are producible by means of a tuning peg cutter. This thereby results in more economical fabrication and storage since the number of basic models can be kept small.

It is particularly very advantageous, if at least the region of contact of the fixing part is made of a material which is such that the moment of static friction of the fixing part on the peg box and the moment of sliding friction differ by at most 40%, preferably by at most 30% and particularly preferred by at most 20%. Provision is made, in particular, for the moment of static friction and the moment of sliding friction to differ by at most 15%. The stick-slip effect is thereby effectively reduced so that the tuning of the stringed musical instrument is made easier.

It is particularly advantageous, if at least the region of contact of the fixing part is made of a material which is such that the moment of static friction on the peg box is smaller than 400 Nmm. The stick-slip effect can thereby be reduced since the threshold for the rotational process is reduced.

For the same reason, it is expedient if at least the region of contact of the fixing part is made of a material which is such that the moment of sliding friction of the fixing part on the peg box is greater than 300 Nmm. The difference between the moment of static friction and the moment of sliding friction can thereby be reduced in order to reduce the stick-slip effect.

Furthermore, it is expedient if at least the region of contact of the fixing part is made of a material which is such that the coefficient of static friction differs by at most 25% from the coefficient of sliding friction. A simple tuning process can thereby be obtained.

For the same reason, it is expedient if at least the region of contact of the fixing part is made of a material which is such that the coefficient of static friction with lubrication, for example by means of curd soap, differs by at most 15% from the coefficient of sliding friction.

Likewise, it is expedient if at least the region of contact of the fixing part is made of a material which is such that the coefficient of static friction on the peg box is smaller than 0.22 without lubrication. The stick-slip effect can thereby be effectively reduced.

For the same reason, it is expedient if at least the region of contact of the fixing part is made of a material which is such that the coefficient of sliding friction of the fixing part on the peg box is smaller than 0.18 without lubrication.

Furthermore, it is expedient if at least the region of contact of the fixing part is made of a material which is such that the coefficient of static friction of the fixing part on the peg box with lubrication (for example by means of tuning peg soap or curd soap) is smaller than 0.12.

Likewise, it is expedient if at least the region of contact of the fixing part is made of a material which is such that the coefficient of sliding friction of the fixing part on the peg box with lubrication is smaller than 0.11.

It is especially very advantageous, if at least the region of contact of the fixing part is made of polyamide. Polyamide can be used without fibre reinforcement. It has the requisite surface properties for effectively reducing the stick-slip effect and producing less wear. Polyamide can also be worked by a tuning peg cutter. Furthermore, it is possible to manufacture the tuning peg element in one piece and thus in an economical manner.

It is in principle possible for the tuning peg element to comprise regions which are made of different materials. For example, the fixing part may be provided with an internal core (made, for example, of wood or metal) whilst a shell made of non-fibrous material is seated on said core. The fixing part can be manufactured economically if it is formed in one piece. In corresponding manner, the tuning peg element can be manufactured economically if it is formed in one piece.

In particular, at least the region of contact of the fixing part is made of a synthetic material and preferably, a homogeneous synthetic material. By appropriate choice of material, a lesser amount of wear and a decrease in the stick-slip effect can then be achieved. In the case of wooden tuning peg elements, the problem also arises that they can get wedged-in due to absorption of moisture from the air and the swelling of the wood caused thereby. This is prevented by the use of synthetic materials.

It is expedient, if at least the region of contact of the fixing part but preferably the entire tuning peg element is manufactured by means of an injection moulding process. The fixing part or the tuning peg element is then an injection moulded item. A tuning peg element having the requisite properties can thereby be manufactured in a simple and economical manner.

The following description of preferred embodiments serves to provide a more detailed explanation of the invention taken in conjunction with the drawings.

### BRIEF DESCRIPTION OF THE DRAWINGS

FIG. 1 shows a side view of a violin serving as an example of a stringed musical instrument;

FIG. 2 shows a plan view of an exemplary embodiment of a tuning peg element in accordance with the invention; and

FIG. 3 shows a schematic illustration of a peg box of a stringed musical instrument in which tuning peg elements in accordance with FIG. 2 are arranged.

### DETAILED DESCRIPTION OF THE INVENTION

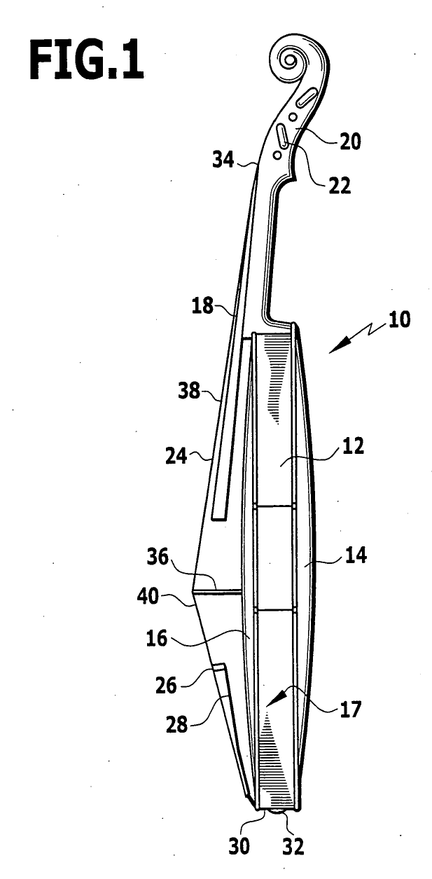

As shown in FIG. 1, a violin 10 serving as an example of a stringed musical instrument comprises a rib 12 having a base 14 and a top 16 which form the main body 17. A finger board 18, which, in turn, has a peg box 20 seated thereon, is arranged on the rib 12. The peg box 20 is made of wood such as maple wood for example. Tuning peg elements 22, by means of which the strings 24 of the violin 10 can be fixed at one end thereof to the peg box 20, are arranged on the peg box 20.

At their other ends 26, the strings 24 are fixed to a tailpiece 28. This tailpiece 28 has a tail gut 30 which forms a suspension string arch. The suspension string arch is hung on a tail pin 32 in order to hold the tailpiece 28.

If the end 26 of a string 24 is fixed relative to the rib 12 by means of the tailpiece 28, then the tension on the string 24 can be altered by means of the associated tuning peg element 22 and the string can thereby be tuned.

That part of the string 24 lying between a nut 34 of the finger board 18 and a bridge 36 located on the casing 16 is referred to as the primary string 38. That part of the string 24 lying between the bridge 36 and the tailpiece 28 is referred to as the secondary string 40.

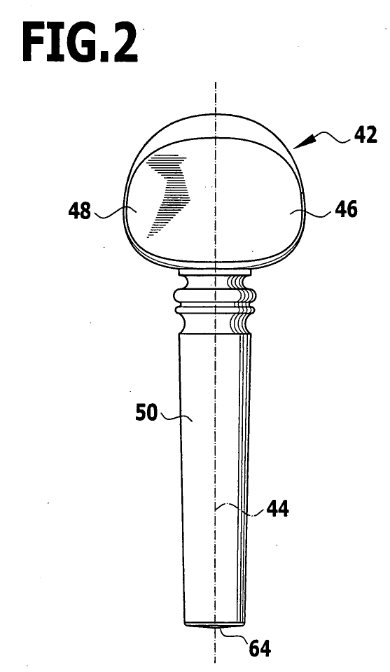

An exemplary embodiment of a tuning peg element in accordance with the invention, which is shown in FIG. 2 and designated therein by the general reference 42, extends in a longitudinal direction coaxially relative to an axis 44 which coincides with an axis of rotation when the tuning peg element 42 is fixed in rotatable manner to the peg box 20. The tuning peg element 42 comprises an actuating portion 46 by means of which the user can grasp the tuning peg element 42 and produce a rotary movement. The actuating portion 46 is, for example, formed by means of a flat actuator element 48; for example, the actuator element 48 is disk-shaped or plate-shaped.

Away from the actuating portion 46, the tuning peg element 42 is substantially rotationally symmetrical about the axis 44.

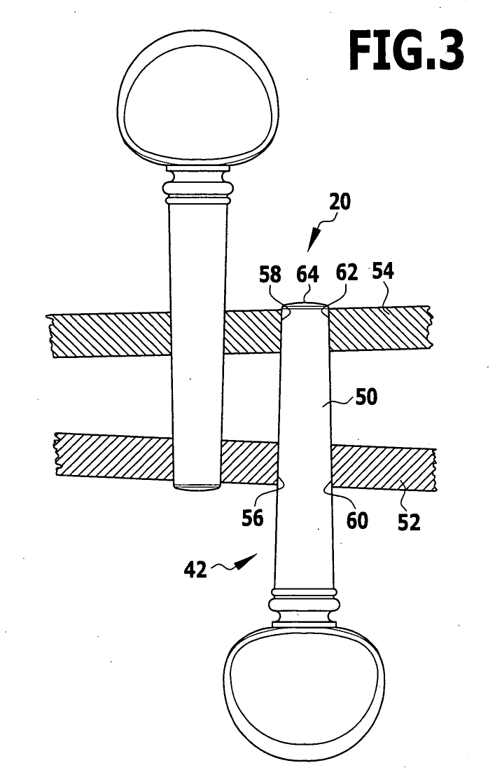

The tuning peg element 42 comprises a fixing part 50 which serves for fixing it to the peg box 20. For example, the peg box 20 has a first strip 52 made of wood and a second strip 54 made of wood (FIG. 3). The two strips 52 and 54 are spaced from one another. The strings 24 of the stringed musical instrument 10 are fed between the two strips 52 and 54. A tuning peg element 42 is adapted to be fixed to the first strip 52 and to the second strip 54 by means of the fixing part 50. The first strip 52 has a rotationally symmetrical bore 56 for accommodating the tuning peg element 42. Likewise, the second strip 54 has a rotationally symmetrical bore 58 which is precisely aligned with the bore 56. The fixing part 50 touches the peg box 20 in the bores 56, 58 at a region of contact.

The bores 56 and 58 are, in particular, conical and have a small cone angle which is in the order of magnitude of 2° for example. Accordingly, the fixing part 50 is also of conical construction and is in the form of a truncated cone for example. An imaginary cone tip lies on the axis 44 at the side remote from the actuating portion 46.

The fixing part 50 is of solid construction and is formed in one piece or of several pieces; it is made of a solid material and contains no recesses in the end faces thereof nor in at least those portions thereof which extend through the bores 56 and 58 in order to fix the tuning peg element 22 to the peg box 20. The fixing part 50 is, for example, a homogeneous closed block of material on which no further auxiliary fixing means are arranged. Fixing is effected exclusively by the outer surface of the fixing part 50 by virtue of frictional contact without force being applied thereto by auxiliary means.

A front end face 64 of the tuning peg element 42 is formed by the corresponding front end face of the fixing part 50 and thus by the solid material of the fixing part 50. This front end face 64 is closed. It has a flat frontal surface for example.

The bores 56 and 58 are bounded by the respective walls 60, 62. The outer surface of the fixing part 50 is in mechanical contact with these walls 60 and 62. In order to rotate the tuning peg element 42, it is necessary to overcome a moment of static friction and a moment of sliding friction which are determined by the material of the fixing part 50 and the material of the peg box 20. Furthermore, the movement of the fixing part 50 in the bores 56 and 58 is characterized by a coefficient of static friction and a coefficient of sliding friction which again are determined by the materials of the fixing part 50 and the peg box 20.

In accordance with the invention, the fixing part 50 is made of a non-fibrous material and in particular a homogeneous synthetic material at least in the region of contact with the peg box 20. The fixing part 50 has a smooth homogeneous surface.

It has been shown that if the fixing part is made of wood then the corresponding tuning peg element wears relatively quickly. This is to be attributed to the fact that the wood fibres in the fixing part run at a transverse angle (of approximately 90° for example) to the direction of the grain of the wooden peg box 20. Thus, in the load direction of the fixing part 50, the end grain of the wooden fibres of the peg box 20 abuts the wood fibres of the fixing part 50 whereby the wear is increased. Furthermore thereby, there is also an increased amount of wear in the bores 56, 58. These must then be re-bored whereby the diameter thereof becomes larger. In the event that the diameter becomes too large, then such a bore 56, 58 could even have to be made smaller by means of a lining bush.

In the case of the solution in accordance with the invention, the wear is reduced since the fixing part 50 is fibre-free in the region of contact

The fixing part 50 is, for example, made entirely of the appropriate material (i.e. solid and homogeneous). In particular, the tuning peg element 42 is formed in one piece and the actuating portion 46 is formed in one piece with the fixing part 50.

The material for the fixing part 50 (at least in the region of contact with the bores 56, 58) has a reduced coefficient of static friction and a reduced coefficient of sliding friction relative to the known tuning peg elements made of wood. Furthermore, the fixing part 50 is made (at least in the region of contact with the bores 56, 58) of a material for which the percentage difference between the coefficient of static friction and the coefficient of sliding friction is reduced in relation to known tuning peg elements made of wood. This applies both for a tuning peg element 42 that is held in the peg box 20 without lubrication as well as for one that is lubricated by means of curd soap or tuning peg soap for example.

Furthermore, the difference between the moment of static friction and the moment of sliding friction in the case of the tuning peg element 42 in accordance with the invention is reduced compared with tuning peg elements made of wood.

In particular, provision is made in accordance with the invention for a material to be selected which is such that when fixed in the dry state the coefficient of static friction is smaller than 0.22 and the coefficient of sliding friction smaller than 0.18. Furthermore, the difference between the coefficient of static friction and the coefficient of sliding friction is at most 25% when fixed in the dry state.

It has proved to be expedient for the fixing part 50 to be made (at least in the region of contact) of a homogeneous synthetic material and in particular, made of polyamide (at least in the region of contact). It is preferred that the fixing part 50 be made of injected polyamide. This synthetic material is not reinforced and has no fibres.

Measurements involving an ebony sample and a polyamide sample (in each case having a contact surface area of 1 cm²) on maple resulted in the following coefficients of static friction and coefficients of sliding friction in the case of a surface pressure of 3.7 N/mm²; here, Δ is the difference between the coefficient of static friction and the coefficient of sliding friction:

TABLE 1

| | Coefficient | Coefficient | |
|---|---|---|---|
| | of static | of sliding | |
| | friction | friction | Δ |
| Ebony, dry | 0.25 | 0.19 | 32% |
| Polyamide, dry | 0.21 | 0.17 | 24% |
| Ebony lubricated with curd | 0.14 | 0.11 | 27% |
| soap | | | |
| Polyamide lubricated with | 0.11 | 0.10 | 10% |
| curd soap | | | |

It is apparent that in the case of the sample made of polyamide, there are smaller coefficients of static friction and coefficients of sliding friction than in the case of the sample made of ebony. Furthermore the percentage difference between the coefficient of static friction and the coefficient of sliding friction is reduced.

In the case of lubrication, the coefficient of static friction is smaller than 0.12, and the coefficient of sliding friction is smaller than 0.11, with the difference between the coefficient of static friction and the coefficient of sliding friction being at most 15%.

Furthermore, measurements have resulted in the following moments of static friction and moments of sliding friction for fixing parts 50 made of ebony and polyamide in a peg box 20 made of maple:

TABLE 2

| | Moment of | Moment of | |
|---|---|---|---|
| | static | sliding | |
| | friction | friction | Δ |
| Fixing element of | 440 Nmm-475 Nmm | 235 Nmm-270 Nmm | 80% |
| ebony | | | |
| Fixing element of | 390 Nmm | 364 Nmm | 10% |
| polyamide | | | |

It is apparent that the moment of sliding friction for a fixing part 50 in accordance with the invention made of polyamide is higher than for a fixing part made of ebony. Furthermore, the moment of sliding friction is more constant, i.e. there is only a small amount of fluctuations.

Furthermore, the difference between the moment of static friction and the moment of sliding friction compared with a tuning peg element made of ebony is greatly reduced. In particular, this difference is below 25%.

The so-called stick-slip effect is reduced by an appropriate choice of material. If a tuning peg element 42 needs to be rotated in the peg box 20 in order to tune a string 24, then a force must initially be exerted in order to reach a rotational threshold. Once the threshold is reached, the force may then be too great and a greater amount of rotation than intended is produced. Consequently, the length of string needed for correct tuning is then below the requisite length and the tuning process must be repeated.

If the tuning peg element 42 in accordance with the invention is fixed to the peg box 20 by means of the fixing part 50, then the surface pressure lies in a range of between approximately 3.1 N/mm² and 4.3 N/mm². Preferably, the surface pressure is approximately 3.7 N/mm². In consequence, secure fixing with uniform distribution of force can be achieved over substantially the entire contact surface of the fixing part together with a simultaneous decrease in the stick-slip effect.

In the solution in accordance with the invention, the moment of static friction is reduced; in particular, it is below 400 Nmm. Furthermore, the moment of sliding friction is at least approximately as large as the moment of static friction. In consequence, the stick-slip effect is reduced.

In accordance with the invention, provision is made for the tuning peg element 42 to be made from a non-fibrous material at least in the region of contact of the fixing part 50 thereof, said material having a reduced coefficient of static friction and a reduced coefficient of sliding friction compared with tuning peg elements made of wood, whereby the difference between the coefficient of static friction and the coefficient of sliding friction is likewise reduced. Furthermore, the difference between the moment of static friction and the moment of sliding friction is reduced. A possible example of such a material is polyamide.

The tuning peg element 42 is held in the peg box 20 by means of the fixing part 50 without further auxiliary means. In particular, no additional clamping means or interlocking means are provided. By appropriate adaptation of the region of contact of the fixing part 50 (the surface with which the fixing part 50 comes into contact with the bores 56, 58), a large surface area for making contact in the bores (at a surface pressure of approximately 3.7 N/mm²) can be achieved. Preferably, the region of contact of the tuning peg element 42 in the bores 56, 58 corresponds to the entire surface area of the fixing part 50 which is positioned in the respective bores. In consequence, the wear is distributed over a maximally large surface area. The tuning peg element 42 can thereby be prevented from slipping inwardly as it wears for example. Furthermore, due to the tuning peg element 42 being fixed in the peg box 20 without further auxiliary means, i.e. merely by means of the fixing part 50, climatic fluctuations can also be optimally accommodated. A high life span of the corresponding tuning peg element can be achieved.

The fixing part 50 is preferably made of a material which is workable by a tuning peg cutter in order to enable the external dimensions of the tuning peg element 42 to be matched to the bores 56, 58.

For example, provision is made for one or more basic models to be made available for a tuning peg element in accordance with the invention, these then being capable of being matched to the particular proportions of an individual stringed musical instrument 10 by treatment with a tuning peg cutter. For example, the appropriate slopes and sizes (in regard to the diameter and length) can be produced by a tuning peg cutter. For example, conical fixing parts 50 having a cone angle 1:20, 1:25 or 1:30 are then produced. Treatment of this type using tuning peg cutters can be effected by an instrument maker. Optimal matching is thereby possible (due to the construction of the fixing part 50 and in particular its region of contact with the peg box 20 of the corresponding stringed musical instrument 10) whilst production costs are reduced; only a small number of basic models (in the simplest case, just one basic model) need to be produced and stored. The process of matching to a specific stringed musical instrument 10 by an instrument maker is in any case necessary.

The material polyamide is workable by a tuning peg cutter.

1. A tuning peg element for a stringed musical instrument having a wooden peg box, comprising:
a conical fixing part by means of which the tuning peg element is fixable to the peg box in rotatable manner without further auxiliary means and which is of solid construction and is made of a non-fibrous material at least in a region of contact with the peg box.

2. A tuning peg element in accordance with claim 1, wherein the surface pressure on the fixing part is between 3.1 N/mm² and 4.3 N/mm² when the tuning peg element is fixed to the peg box.

3. A tuning peg element in accordance with claim 1, wherein the end face of the fixing part is free of recesses.

4. A tuning peg element in accordance with claim 1, wherein a front end face is formed on the fixing part.

5. A tuning peg element in accordance with claim 4, wherein the front end face is closed.

6. A tuning peg element in accordance with claim 4, wherein the front end face is formed by the solid material of the fixing part.

7. A tuning peg element in accordance with claim 1, wherein the fixing part has a region of contact with the peg box which substantially corresponds to that region of the surface which is positioned in a bore in the peg box.

8. A tuning peg element in accordance with claim 1, wherein the fixing part is workable by a tuning peg cutter.

9. A tuning peg element in accordance with claim 8, one or more basic models being provided, from which tuning peg elements of at least one of differing conical slopes and different sizes are producible by means of a tuning peg cutter.

10. A tuning peg element in accordance with claim 1, wherein at least the region of contact of the fixing part is made of a material which is such that the moment of static friction of the fixing part on the peg box and the moment of sliding friction differ by at most 40%.

11. A tuning peg element in accordance with claim 1, wherein at least the region of contact of the fixing part is made of a material which is such that the moment of static friction of the fixing part on the peg box and the moment of sliding friction differ by at most 30%.

12. A tuning peg element in accordance with claim 1, wherein at least the region of contact of the fixing part is made of a material which is such that the moment of static friction of the fixing part on the peg box and the moment of sliding friction differ by at most 20%.

13. A tuning peg element in accordance with claim 1, wherein at least the region of contact of the fixing part is made of a material which is such that the moment of static friction of the fixing part on the peg box is smaller than 400 Nmm.

14. A tuning peg element in accordance with claim 1, wherein at least the region of contact of the fixing part is made of a material which is such that the moment of sliding friction of the fixing part on the peg box is greater than 300 Nmm.

15. A tuning peg element in accordance with claim 1, wherein at least the region of contact of the fixing part is made of a material which is such that the coefficient of static friction differs by at most 25% from the coefficient of sliding friction.

16. A tuning peg element in accordance with claim 1, wherein at least the region of contact of the fixing part is made of a material which is such that the coefficient of static friction with lubrication differs by at most 15% from the coefficient of sliding friction.

17. A tuning peg element in accordance with claim 1, wherein at least the region of contact of the fixing part is made of a material which is such that the coefficient of static friction is smaller than 0.22 without lubrication.

18. A tuning peg element in accordance with claim 1, wherein at least the region of contact of the fixing part is made of a material which is such that the coefficient of sliding friction is smaller than 0.18 without lubrication.

19. A tuning peg element in accordance with claim 1, wherein at least the region of contact of the fixing part is made of a material which is such that the coefficient of static friction with lubrication is smaller than 0.12.

20. A tuning peg element in accordance with claim 1, wherein at least the region of contact of the fixing part is made of a material which is such that the coefficient of sliding friction with lubrication is smaller than 0.11.

21. A tuning peg element in accordance with claim 1, wherein at least the region of contact of the fixing part is made of polyamide.

22. A tuning peg element in accordance with claim 1, wherein the fixing part is formed in one piece.

23. A tuning peg element in accordance with claim 1, said tuning peg element being a one piece construction.

24. A tuning peg element in accordance with claim 1, wherein at least the region of contact of the fixing part is made of a synthetic material.

25. A tuning peg element in accordance with claim 1, wherein at least the region of contact of the fixing part is made by means of an injection moulding process.
